(19) United States
(12) Patent Application Publication
(10) Pub. No.: US 2016/0275877 A1
(43) Pub. Date: Sep. 22, 2016

(54) FIELD SEQUENTIAL COLOR DISPLAY DEVICE AND COLOR CONTROL METHOD THEREOF

(71) Applicant: SHENZHEN CHINA STAR OPTOELECTRONICS TECHNOLOGY CO., LTD., Shenzhen (CN)

(72) Inventor: Yong FAN, Shenzhen (CN)

(73) Assignee: Shenzhen China Star Optoelectronics Technology Co., Ltd., Shenzhen (CN)

(21) Appl. No.: 14/370,776

(22) PCT Filed: Jun. 24, 2014
(86) PCT No.: PCT/CN2014/080629

§ 371 Date: Jul. 5, 2014

(30) Foreign Application Priority Data
Jun. 20, 2014 (CN) 201410280891.0

(51) Int. Cl. G09G 3/34; G09G 3/36; G02F 1/1335

(52) U.S. Cl. CPC G09G 3/3413; G02F 1/133621; G02F 1/133514; G09G 3/3607; G02F 2001/133622; G09G 2310/0235; G09G 2300/0443; G09G 2300/0452; G09G 2320/064; G09G 2320/0666

(57) ABSTRACT

A field sequential color (FSC) display device is provided. The FSC display device includes a liquid crystal display (LCD) panel and a backlight module. The LCD panel includes color filters of a first color sub-pixel, a second color sub-pixel and a third sub-pixel. A frame period is divided sequentially into a first sub-frame period and a second sub-frame period. The backlight module is for providing a backlight source to the LCD panel. The backlight source includes a red backlight, a blue backlight and a green backlight. The backlight module provides two color backlights of the three color backlights in a first backlighting period of the first sub-frame period, and provides the third color backlight of the three color backlights in a second backlighting period of the second sub-frame period. Moreover, a color control method of a FSC display device also is provided.

### TECHNICAL FIELD

The present invention relates to the field of display technology, and particularly to a field sequential color display device and a color control method thereof

### DESCRIPTION OF RELATED ART

With the development of electro-optical and semiconductor technologies, the development of flat panel display devices is promoted. In various types of flat panel display devices, the liquid crystal display device has becoming a mainstream of market owing to its superior characteristics of high space utilization efficiency, low power consumption, radiation free and low electromagnetic interference, and so on.

The liquid crystal display device generally includes a liquid crystal display panel and a backlight module. Since the non-self-emissive characteristic of the liquid crystal display panel, it is necessary to dispose the backlight module below the liquid crystal display panel to provide a surface light source for the liquid crystal display panel, and the liquid crystal display panel display an image on the assist of the surface light source provided by the backlight module.

According to mixing manners of color display, temporal mixing and spatial mixing (for example strip alignment method or color concurrent method) categories are classified. At present, the display devices usually use the spatial strip alignment method. A thin film transistor liquid crystal display (TFT-LCD) device is taken as an example, and each display pixel is constituted by color filters of RGB three sub-pixels. Generally speaking, when the size of each sub-pixel is much smaller than the distinguishing range of human eye, a color mixing effect can be achieved in human visual perception.

If the spatial mixing of TFT-LCD device is replaced by the temporal mixing, there is no need of the color filters to constitute color mixing effect. By using backlight sources with different colors in combination with corresponding data display, the temporal color mixing effect can be achieved. Moreover, the transmittance of device can be increased and the device cost can be reduced.

FIG. 1 is a driving circuit architecture diagram of a field sequential color display device 110 in the prior art. As illustrated in FIG. 1, a sequential color controller 120 is configured to convert spatial parallel RGB video data from a video source system terminal into temporal serial RGB video data as output, i.e., the so-called sequential color method. Subsequently, the sequential color controller 120 control the backlight module 130 cooperative with different color image data to generate corresponding light sources, and thereby achieving the color image display on the display panel 140.

Moreover, in order to avoid undesired color mixing when data is writing during a writing period of RGB data, the backlight source is necessary to perform on-off operations in collocation with the data writing, and a driving waveform is illustrated in FIG. 2. FIG. 2 is a driving wave diagram of the field sequential color display device in FIG. 1. Referring to FIG. 2, the backlight source is turned off when the data is writing, and the backlight source is turned on after the writing of data is completed. As a result, the RGB temporal color mixing can be achieved and undesired color mixing can be avoided. In addition, since the sequential color method divides a color image into three primary colors R, G, B images, if the three primary colors R, G, B images are sequentially displayed in one frame of time, the image frequency must be up to 180 Hz, and the liquid crystal response time must be less than 5.56 ms so as to avoid the occurrence of undesired color mixing.

However, because of human eye's instinct of random saccades or pursuit of moving object in picture, differently-colored color fields of object would not fall at a same point of retina. Therefore, when using the field sequential color display device, the human eye in the visual system will feel the edges of object appear the color break-up (CBU) phenomenon. The occurrence of CBU phenomenon is that: a color image contains three color fields, corresponding pixels are projected on different positions of retina and perceived in human-visual system, and the viewer would watch a color break-up image. In addition, besides deteriorating the image quality, according to some reports, after a long time watching, the CBU phenomenon would cause dizziness feeling.

In order to improve the CBU phenomenon, in recent years, a field sequential color display device with a display pixel constituted by color filters of two color sub-pixels (e.g., red-green sub-pixels, red-blue sub-pixels, or green-blue sub-pixels) and one transparent sub-pixel has been proposed. As to the field sequential color display device with a display pixel constituted by color filters of red (B), blue (B) and transparent (T) sub-pixels, an architecture thereof is illustrated in FIG. 3. FIG. 3 is a schematic structural view of another field sequential color display device in the prior art.

Referring to FIG. 3, in a first sub-frame period, light valves for controlling liquid crystal molecule in liquid crystal regions 330 corresponding to the color filters of the R, B, T sub-pixels all are turned on. In a first backlighting period of the first sub-frame period, the backlight module 310 provides blue and red backlights, the color filter of the transparent sub-pixel ideally allows magenta light synthesized by blue light and red light to pass through, the color filter of the red sub-pixel ideally allows the red light in the backlights to pass through, the color filter of the blue sub-pixel ideally allows the blue light in the backlights to pass through, and thereby the liquid crystal display panel 320 can display a M, R, B three-color image.

In a second sub-frame period, the light valves for controlling liquid crystal molecule in the liquid crystal regions 330 corresponding to the color filters of red and blue sub-pixels are turned off, while the light value for controlling liquid crystal molecules in the liquid crystal region 330 corresponding to the color filter of the transparent sub-pixel is turned on. In a second backlighting period of the second sub-frame period, the backlight module 310 provides a green backlight, the color filter of the transparent sub-pixel ideally allows the green backlight to pass through, the color filters of the red and blue sub-pixels are opaque to the green backlight, and thereby the liquid crystal display panel 320 can display a green (G) image.

Therefore, in a frame period (i.e., the first sub-frame period and the second sub-frame period), the liquid crystal display panel 320 sequentially displays a three-color M, G, B image and a green image, and thereby displays a complete image. However, in the second sub-frame period, the color filters of the red and blue sub-pixels are opaque, resulting in the light transmittance of the liquid crystal display panel 320 in the second sub-frame period is low and going against the reduction of power consumption of the backlight module 310.

### SUMMARY

In order to solve the problem in the prior art, an objective of the present invention is to provide a field sequential color display device. The field sequential color display device includes a liquid crystal display panel and a backlight module. The liquid crystal display panel includes a color filter of a first color sub-pixel, a color filter of a second color sub-pixel and a color filter of a third sub-pixel. A frame period of the liquid crystal display panel is divided sequentially into a first sub-frame period and a second sub-frame period. The backlight module is configured (i.e., structured and arranged) for providing a backlight source to the liquid crystal display panel. The backlight source includes a red backlight, a blue backlight and a green backlight. In a first backlighting period of the first sub-frame period, the backlight module provides two color backlights of the three color backlights and thereby the color filter of the first color sub-pixel allows one color backlight of the two color backlights to pass through, the color filter of the second color sub-pixel allows the other one color backlight of the two color backlights to pass through, and the color filter of the third sub-pixel allows the two color backlights to pass through. In a second backlighting period of the second sub-frame period, the backlight module provides the third color backlight of the three color backlights and thereby the color filter of the first color sub-pixel, the color filter of the second color sub-pixel and the color filter of the third sub-pixel all allow the third color backlight of the three color backlights to pass through.

In an exemplary embodiment, the field sequential color display device further includes a sequential color controller. The sequential color controller is configured for supplying two color image data corresponding to the two color backlights of the three color backlights to the liquid crystal display panel in the first sub-frame period, and configured for supplying color image data corresponding to the third color backlight of the three color backlights to the liquid crystal display panel in the second sub-frame period.

In an exemplary embodiment, the sequential color controller is further configured for supplying PWM (pulse width modulation) control signals to the backlight module, respectively for controlling backlight enabling periods of the three color backlights provided by the backlight module. In the first backlighting period of the first sub-frame period, the PWM control signals for controlling the two color backlights of the three color backlights are enabled, while the PWM control signal for controlling the third color backlight of the three color backlights is disabled. In the second backlighting period of the second sub-frame period, the PWM control signals for controlling the two color backlights of the three color backlights are disabled, while the PWM control signal for controlling the third color backlight of the three color backlights is enabled.

In an exemplary embodiment, the color filter of the first color sub-pixel is a color filter of a yellow sub-pixel, the color filter of the second color sub-pixel is a color filter of a cyan sub-pixel, and the color filter of the third sub-pixel is a color filter of a transparent sub-pixel. In the first backlighting period of the first sub-frame period, the backlight module provides the blue backlight and the red backlight of the three color backlights and thereby the color filter of the first color sub-pixel allows the red backlight to pass through, the color filter of the second color sub-pixel allows the blue backlight to pass through, and the color filter of the third sub-pixel allows the red backlight and the blue backlight to pass through. In the second backlighting period of the second sub-frame period, the backlight module provides the green backlights of the three color backlights and thereby the color filter of the first color sub-pixel, the color filter of the second color sub-pixel and the color filter of the third sub-pixel all allow the green backlight to pass through.

In an exemplary embodiment, the color filter of the first color sub-pixel is a color filter of a magenta sub-pixel, the color filter of the second color sub-pixel is a color filter of a yellow sub-pixel, and the color filter of the third sub-pixel is a color filter of a transparent sub-pixel. In the first backlighting period of the first sub-frame period, the backlight module provides the blue backlight and the green backlight of the three color backlights and thereby the color filter of the first color sub-pixel allows the blue backlight to pass through, the color filter of the second color sub-pixel allows the green backlight to pass through, and the color filter of the third sub-pixel allows the green backlight and the blue backlight to pass through. In the second backlighting period of the second sub-frame period, the backlight module provides the red backlights of the three color backlights and thereby the color filter of the first color sub-pixel, the color filter of the second color sub-pixel and the color filter of the third sub-pixel all allow the red backlight to pass through.

In an exemplary embodiment, the color filter of the first color sub-pixel is a color filter of a magenta sub-pixel, the color filter of the second color sub-pixel is a color filter of a cyan sub-pixel, and the color filter of the third sub-pixel is a color filter of a transparent sub-pixel. In the first backlighting period of the first sub-frame period, the backlight module provides the red backlight and the green backlight of the three color backlights and thereby the color filter of the first color sub-pixel allows the red backlight to pass through, the color filter of the second color sub-pixel allows the green backlight to pass through, and the color filter of the third sub-pixel allows the green backlight and the red backlight to pass through. In the second backlighting period of the second sub-frame period, the backlight module provides the blue backlights of the three color backlights and thereby the color filter of the first color sub-pixel, the color filter of the second color sub-pixel and the color filter of the third sub-pixel all allow the blue backlight to pass through.

Another objective of the present invention is to provide a color control method of a field sequential color display device. The field sequential color display device includes a liquid crystal display panel and a backlight module. The liquid crystal display panel includes a color filter of a first color sub-pixel, a color filter of a second color sub-pixel and a color filter of a third sub-pixel. The backlight module is configured for providing a backlight source to the liquid crystal display panel. The backlight source includes a red backlight, a blue backlight and a green backlight. In particular, the color control method includes: dividing a frame period of the liquid crystal display panel sequentially into a first sub-frame period and a second sub-frame period; in a first backlighting period of the first sub-frame period, providing two color backlights of the three color backlights and thereby the color filter of the first color sub-pixel allowing one color backlight of the two color backlights to pass through, the color filter of the second color sub-pixel allowing the other one color backlight of the two color backlights to pass through, and the color filter of the third sub-pixel allowing the two color backlights to pass through; and in a second backlighting period of the second sub-frame period, providing the third color backlight of the three color backlights and thereby the color filter of the first color sub-pixel, the color filter of the second color sub-pixel and the color filter of the third sub-pixel all allow the third color backlight of the three color backlights to pass through.

In an exemplary embodiment, before the step of providing the two color backlights of the three color backlights in a first backlighting period of the first sub-frame period, the color control method further includes supplying two color image data corresponding to the two color backlights to the liquid crystal display panel in the first sub-frame period; and before the step of providing the third color backlight of the three color backlights in a second backlighting period of the second sub-frame period, the color control method further includes supplying color image data corresponding to the third color backlight of the three color backlights to the liquid crystal display panel in the second sub-frame period.

In an exemplary embodiment, the step of providing the two color backlights of the three color backlights in a first backlighting period of the first sub-frame period includes that: in the first backlighting period of the first sub-frame period, enabling the PWM control signals for controlling the two color backlights of the three color backlights, while disabling the PWM control signal for controlling the third color backlight of the three color backlights. The step of providing the third color backlight of the three color backlights in a second backlighting period of the second sub-frame period includes that: in the second backlighting period of the second sub-frame period, disabling the PWM control signals for controlling the two color backlights of the three color backlights, while enabling the PWM control signal for controlling the third color backlight of the three color backlights.

In an exemplary embodiment, the color filter of the first color sub-pixel is a color filter of a yellow sub-pixel, the color filter of the second color sub-pixel is a color filter of a cyan sub-pixel, and the color filter of the third sub-pixel is a color filter of a transparent sub-pixel. Or, the color filter of the first color sub-pixel is a color filter of a magenta sub-pixel, the color filter of the second color sub-pixel is a color filter of a yellow sub-pixel, and the color filter of the third sub-pixel is a color filter of a transparent sub-pixel. Even or, the color filter of the first color sub-pixel is a color filter of a magenta sub-pixel, the color filter of the second color sub-pixel is a color filter of a cyan sub-pixel, and the color filter of the third sub-pixel is a color filter of a transparent sub-pixel.

The field sequential color display device and the color control method thereof according to various exemplary embodiments of the present invention, besides improve the color break-up phenomenon, by turning on all the light valves for controlling liquid crystal molecules in sub-pixel regions respectively corresponding to the color filter of the first color sub-pixel, the color filer of the second color sub-pixel and the color filter of the third sub-pixel in the second sub-frame period, solve the low transmittance problem of the liquid crystal display panel in the second sub-frame period and also facilitates to reduce the power consumption of backlight module.

### BRIEF DESCRIPTION OF THE DRAWINGS

The above embodiments will become more readily apparent to those ordinarily skilled in the art after reviewing the following detailed description and accompanying drawings.

FIG. 1 is a driving circuit architecture diagram of a field sequential color display device in the prior art.

FIG. 2 is a driving wave diagram of the field sequential color display device in FIG. 1.

FIG. 3 is a schematic structural view of another field sequential color display device in the prior art.

FIG. 4 is a driving circuit architecture diagram of a field sequential color display device according to a first exemplary embodiment of the present invention.

FIG. 5 is a schematic cross-sectional view of a liquid crystal display panel according to the first exemplary embodiment of the present invention.

FIG. 6 is a driving wave diagram of the field sequential color display device according to the first exemplary embodiment of the present invention.

FIG. 7 is a schematic partial cross-sectional view of a liquid crystal display panel according to a second exemplary embodiment of the present invention.

FIG. 8 is a driving wave diagram of a field sequential color display device according to the second exemplary embodiment of the present invention.

FIG. 9 is a schematic partial cross-sectional view of a liquid crystal display panel according to a third exemplary embodiment of the present invention.

FIG. 10 is a driving wave diagram of a field sequential color display device according to the third exemplary embodiment of the present invention.

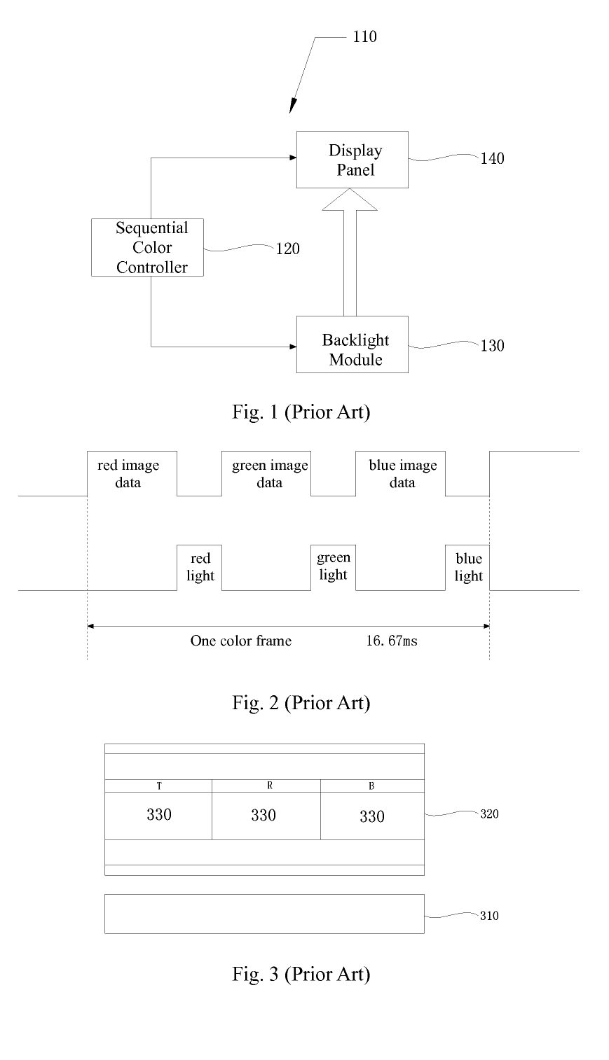

### DETAILED DESCRIPTION OF EMBODIMENTS

The present invention will now be described more specifically with reference to the following embodiments and accompanying drawings. It is to be noted that the following descriptions of embodiments are presented herein for purpose of illustration and description only. It is not intended to be exhaustive or to be limited to the precise form disclosed.

In the drawings, the same reference numerals will be used to refer to the same elements. It will be understood that, although the terms first, second, etc. may be used herein to describe various elements, these elements should not be limited by these terms. These terms are only used to distinguish one element from another element.

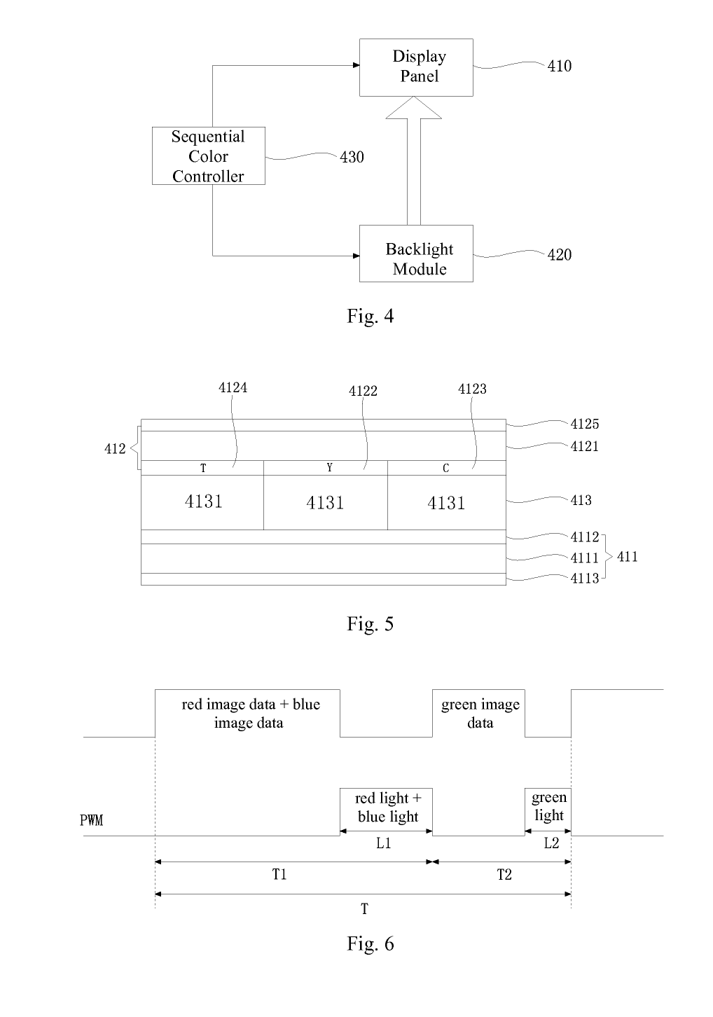

FIG. 4 is a driving circuit architecture diagram of a field sequential color display device according to a first exemplary embodiment of the present invention. FIG. 5 is a schematic cross-sectional view of a liquid crystal display panel according to the first exemplary embodiment. FIG. 6 is a driving wave diagram of the field sequential color display device according to the first exemplary embodiment.

Referring to FIGS. 4 through 6, a field sequential color display device according to a first exemplary embodiment of the present invention includes a liquid crystal display panel 410, a backlight module 420, and a sequential color controller 430.

The liquid crystal display panel 410 includes a thin film transistor (TFT) array substrate 411, a color filter substrate 412, and a liquid crystal layer 413 sandwiched between the two substrates 411, 412.

The TFT array substrate 411 includes a glass substrate 4111, thin film transistors 4112 formed on the glass substrate 4111 and arranged in an array, and a first polarizer 4113 arranged below the glass substrate 4111. The color substrate 412 is oppositely disposed with the TFT array substrate 411 and includes a transparent substrate 4121, a color filter 4122 of a first color sub-pixel, a color filter 4123 of a second color sub-pixel and a color filter 4124 of a transparent (T) sub-pixel arranged between the transparent substrate 4121 and the liquid crystal layer 413, and a second polarizer 4125 formed on the transparent substrate 4121. The color filter 4122 of the first color sub-pixel, the color filter 4123 of the second color sub-pixel and the color filter 4124 of the transparent sub-pixel together constitute a display pixel. In the exemplary embodiment, the color filters are made of filmy plastic plate or glass plate.

The liquid crystal layer 413 includes multiple partitioned sub-pixel regions 4131. Each of the sub-pixel regions 4131 is filled with liquid crystal molecules. The color filter 4122 of the first color sub-pixel, the color filter 4123 of the second color sub-pixel and the color filter 4124 of the transparent sub-pixel each are corresponding to one of the sub-pixel regions 4131.

A frame period T of the liquid crystal display panel 410 is divided sequentially into a first sub-frame period T1 and a second sub-frame period T2. On the timeline, the conventional frame rate is 60 frames per second, i.e., the liquid crystal display panel 410 displays a complete color image about each 16.67 milliseconds. Accordingly, the field sequential color display device according to the exemplary embodiment of the present invention needs to increase the frame rate up to for example 120 frames per second, i.e., each sub-frame is displayed with ( 1/120=8.33) milliseconds, and two sub-frames are needed to constitute a complete color image.

In the exemplary embodiment, the backlight module 420 provides a backlight source for the liquid crystal display panel 410. The backlight source includes a red (R) backlight, a blue (B) backlight and a green (G) backlight. and correspondingly the backlight module 420 may include a red light source, a blue light source and a green light source. In the first sub-frame period T1 and the second sub-frame period T2, light valves for controlling liquid crystal molecules in the sub-pixel regions 4131 respectively corresponding to the color filter 4122 of the first color sub-pixel, the color filter 4123 of the second color sub-pixel and the color filter 4124 of the transparent sub-pixel all are turned on by the sequential color controller 430, and red image data, blue image data and green image data are sequentially written into the liquid crystal display panel 410 in the first sub-frame period T1 and the second sub-frame T2. Meanwhile, the sequential color controller 430 controls the backlight module 420 to provide corresponding color backlights for the liquid crystal display panel 410 in the first sub-frame period T1 and the second sub-frame period T2, and thereby facilitating the liquid crystal display panel 410 to display.

In the exemplary embodiment, the color filter 4122 of the first color sub-pixel is a color filter of a yellow (Y) sub-pixel, and the color filter 4123 of the second color sub-pixel is a color filter of a cyan (C) sub-pixel.

Therefore, the backlight module 420 provides a magenta (M) backlight in a first backlighting period L1 of the first sub-frame period T1, the color filter 4124 of the transparent sub-pixel ideally allows the magenta light synthesized by blue light and red light to pass through, the color filter 4122 of the first color sub-pixel ideally allows red light in the backlight to pass through, the color filter 4123 of the second color sub-pixel ideally allows the blue light in the backlight to pass through, and thereby the liquid crystal display panel 410 can display red image data and blue image data. In a second backlighting period L2 of the second sub-frame period T2, the backlight module 420 provides a green (B) backlight, the color filter 4124 of the transparent sub-pixel, the color filter 4122 of the first color sub-pixel and the color filter 4123 of the second color sub-pixel ideally all allow the green light to pass through, and thereby the liquid crystal display panel 410 displays green image data.

Backlight enabling periods of red (R) backlight, blue (B) backlight and green (G) backlight provided by the backlight module 420 can be controlled by duty cycles of corresponding PWM control signals provided by the sequential color controller 430. The magenta (M) backlight can be constituted by red and blue backlights. Correspondingly, in the first backlighting period L1, the PWM control signal for controlling the green backlight is disabled while the PWM control signals for controlling the red and blue backlights are enabled; and in the second backlighting period L2, the PWM control signals for controlling the red and blue backlights are disabled while the PWM control signal for controlling the green backlight is enabled.

In summary, the field sequential color display device according to the first exemplary embodiment of the present invention, besides improves the color break-up phenomenon, by turning on all the light valves for controlling liquid crystal molecules in the sub-pixel regions 4131 respectively corresponding to the color filter 4122 of the first color sub-pixel, the color filer 4123 of the second color sub-pixel and the color filter of the transparent sub-pixel in the second sub-frame period T2, solves the low transmittance problem of the liquid crystal display panel in the second sub-frame period and also facilitates to reduce the power consumption of backlight module.

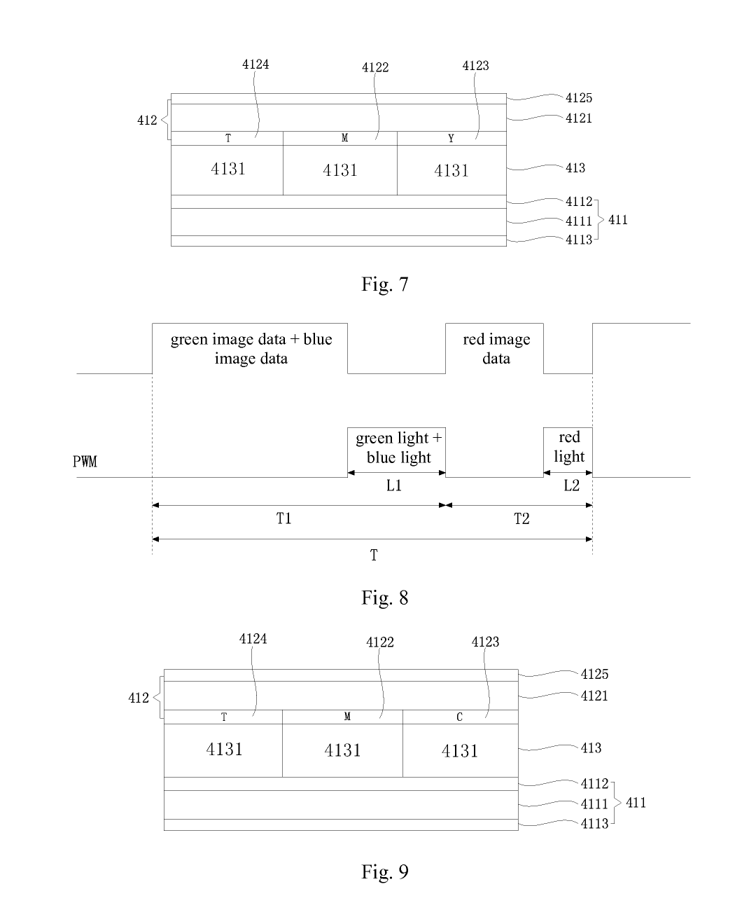

FIG. 7 is a schematic partial cross-sectional view of a liquid crystal display panel according to a second exemplary embodiment of the present invention. FIG. 8 is a driving wave diagram of a field sequential color display device according to the second exemplary embodiment.

Herein, only differences between the second exemplary embodiment and the first exemplary embodiment will be described, and what are the same as that of the first exemplary embodiment will not be described. Referring to FIGS. 7 and 8, the differences from the first exemplary embodiment are that: in the second exemplary embodiment, the color filter 4122 of the first color sub-pixel is a color filter of a magenta (M) sub-pixel, and the color filter 4123 of the second color sub-pixel is a color filter of a yellow (Y) sub-pixel.

Accordingly, the backlight module 420 will provide a cyan (C) backlight in the first backlighting period L1 of the first sub-frame period T1, the color filter 4124 of the transparent sub-pixel ideally allows the cyan (C) light synthesized by blue light and green light to pass through, the color filter 4122 of the first color sub-pixel ideally allows the blue light in the backlight to pass through, the color filter 4123 of the second color sub-pixel ideally allows the green light in the backlight to pass through, and thereby the liquid crystal display panel 410 displays green image data and blue image data. In the second backlighting period L2 of the second sub-frame period T2, the backlight module 420 provides a red (R) backlight, the color filter 4124 of the transparent sub-pixel, the color filter 4122 of the first color sub-pixel and the color filter 4123 of the second color sub-pixel ideally all allow the red light to pass through, and thereby the liquid crystal display panel 410 displays red image data.

Backlight enabling periods of red (R) backlight, blue (B) backlight and green (G) backlight provided by the backlight module 420 can be controlled by duty cycles of corresponding PWM control signals provided by the sequential color controller 430. The cyan (C) backlight can be constituted by green and blue backlights. Correspondingly, in the first backlighting period L1, the PWM control signal for controlling the red backlight is disabled while the PWM control signals for controlling the green and blue backlights are enabled; and in the second backlighting period L2, the PWM control signals for controlling the green and blue backlights are disabled while the PWM control signal for controlling the red backlight is enabled.

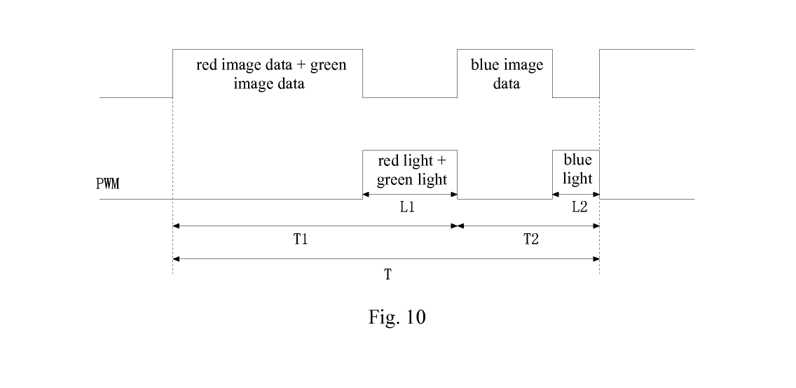

FIG. 9 is a schematic partial cross-sectional view of a liquid crystal display panel according to a third exemplary embodiment of the present invention. FIG. 10 is a driving wave diagram of a field sequential color display device according to the third exemplary embodiment.

Herein, only differences between the third exemplary embodiment and the above (i.e., the first and second) exemplary embodiments will be described, and what are the same as that of the above exemplary embodiments will not be described. Referring to FIGS. 9 and 10, the differences from the above exemplary embodiment are that: in the third exemplary embodiment, the color filter 4122 of the first color sub-pixel is a color filter of a magenta (M) sub-pixel, and the color filter 4123 of the second color sub-pixel is a color filter of a cyan (C) sub-pixel.

Accordingly, the backlight module 420 will provide a yellow (Y) backlight in the first backlighting period L1 of the first sub-frame period T1, the color filter 4124 of the transparent sub-pixel ideally allows the yellow (Y) light synthesized by red light and green light to pass through, the color filter 4122 of the first color sub-pixel ideally allows the red light in the backlight to pass through, the color filter 4123 of the second color sub-pixel ideally allows the green light in the backlight to pass through, and thereby the liquid crystal display panel 410 displays green image data and red image data. In the second backlighting period L2 of the second sub-frame period T2, the backlight module 420 provides a blue (B) backlight, the color filter 4124 of the transparent sub-pixel, the color filter 4122 of the first color sub-pixel and the color filter 4123 of the second color sub-pixel ideally all allow the blue light to pass through, and thereby the liquid crystal display panel 410 displays blue image data.

Backlight enabling periods of red (R) backlight, blue (B) backlight and green (G) backlight provided by the backlight module 420 can be controlled by duty cycles of corresponding PWM control signals provided by the sequential color controller 430. The yellow (Y) backlight can be constituted by green and red backlights. Correspondingly, in the first backlighting period L1, the PWM control signal for controlling the blue backlight is disabled while the PWM control signals for controlling the green and red backlights are enabled; and in the second backlighting period L2, the PWM control signals for controlling the green and red backlights are disabled while the PWM control signal for controlling the blue backlight is enabled.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A field sequential color display device comprising:
a liquid crystal display panel, comprising a color filter of a first color sub-pixel, a color filter of a second color sub-pixel and a color filter of a third sub-pixel, wherein a frame period is divided sequentially into a first sub-frame period and a second sub-frame period; and
a backlight module, configured for providing a backlight source to the liquid crystal display panel, wherein the backlight source comprises a red backlight, a blue backlight and a green backlight;
wherein in a first backlighting period of the first sub-frame period, the backlight module provides two color backlights of the three color backlights, and thereby the color filter of the first color sub-pixel allows one color backlight of the two color backlights to pass through, the color filer of the second color sub-pixel allows the other one color backlight of the two color backlights to pass through, and the color filter of the third sub-pixel allows the two color backlights to pass through;
wherein in a second backlighting period of the second sub-frame period, the backlight module provides the third color backlight of the three color backlights, and thereby the color filter of the first color sub-pixel, the color filer of the second color sub-pixel and the color filter of the third sub-pixel all allows the third color backlight of the three color backlights to pass through.

2. The field sequential color display device as claimed in claim 1, further comprising:
a sequential color controller, configured for supplying two color image data corresponding to the two color backlights of the three color backlights to the liquid crystal display panel in the first sub-frame period, and supplying color image data corresponding to the third color backlight of the three color backlights to the liquid crystal display panel in the second sub-frame period.

3. The field sequential color display device as claimed in claim 2, wherein the sequential color controller is configured for supplying the backlight module with PWM control signals for respectively controlling backlight enabling periods of the three color backlights provided by the backlight module;
in the first backlighting period of the first sub-frame period, the PWM signals for controlling the two color backlight of the three color backlights are enabled, while the PWM signal for controlling the third color backlight of the three color backlights is disabled; and
in the second backlighting period of the second sub-frame period, the PWM signals for controlling the two color backlights of the three color backlights are disabled, while the PWM signal for controlling the third color backlight of the three color backlights is enabled.

4. The field sequential color display device as clamed in claim 1, wherein the color filter of the first color sub-pixel is a color filter of a yellow sub-pixel, the color filter of the second color sub-pixel is a color filter of a cyan sub-pixel, and the color filter of the third sub-pixel is a color filter of a transparent sub-pixel;
in the first backlighting period of the first sub-frame period, the backlight module provides the blue backlight and the red backlight of the three color backlights, and thereby the color filter of the first color sub-pixel allows the red backlight to pass through, the color filter of the second color sub-pixel allows the blue backlight to pass through, and the color filter of the third sub-pixel allows the red backlight and the blue backlight to pass through; and
in the second backlighting period of the second sub-frame period, the backlight module provides the green backlight of the three color backlights, and thereby the color filter of the first color sub-pixel, the color filter of the second color sub-pixel and the color filter of the third sub-pixel all allow the green backlight to pass through.

5. The field sequential color display device as claimed in claim 2, wherein the color filter of the first color sub-pixel is a color filter of a yellow sub-pixel, the color filter of the second color sub-pixel is a color filter of a cyan sub-pixel, and the color filter of the third sub-pixel is a color filter of a transparent sub-pixel;
in the first backlighting period of the first sub-frame period, the backlight module provides the blue backlight and the red backlight of the three color backlights, and thereby the color filter of the first color sub-pixel allows the red backlight to pass through, the color filter of the second color sub-pixel allows the blue backlight to pass through, and the color filter of the third sub-pixel allows the red backlight and the blue backlight to pass through; and
in the second backlighting period of the second sub-frame period, the backlight module provides the green backlight of the three color backlights, and thereby the color filter of the first color sub-pixel, the color filter of the second color sub-pixel and the color filter of the third sub-pixel all allow the green backlight to pass through.

6. The field sequential color display device as claimed in claim 3, wherein the color filter of the first color sub-pixel is a color filter of a yellow sub-pixel, the color filter of the second color sub-pixel is a color filter of a cyan sub-pixel, and the color filter of the third sub-pixel is a color filter of a transparent sub-pixel;
in the first backlighting period of the first sub-frame period, the backlight module provides the blue backlight and the red backlight of the three color backlights, and thereby the color filter of the first color sub-pixel allows the red backlight to pass through, the color filter of the second color sub-pixel allows the blue backlight to pass through, and the color filter of the third sub-pixel allows the red backlight and the blue backlight to pass through; and
in the second backlighting period of the second sub-frame period, the backlight module provides the green backlight of the three color backlights, and thereby the color filter of the first color sub-pixel, the color filter of the second color sub-pixel and the color filter of the third sub-pixel all allow the green backlight to pass through.

7. The field sequential color display device as claimed in claim 1, wherein the color filter of the first color sub-pixel is a color filter of a magenta sub-pixel, the color filter of the second color sub-pixel is a color filter of a yellow sub-pixel, and the color filter of the third sub-pixel is a color filter of a transparent sub-pixel;
in the first backlighting period of the first sub-frame period, the backlight module provides the blue backlight and the green backlight of the three color backlights, and thereby the color filter of the first color sub-pixel allows the blue backlight to pass through, the color filter of the second color sub-pixel allows the green backlight to pass through, and the color filter of the third sub-pixel allows the green backlight and the blue backlight to pass through; and
in the second backlighting period of the second sub-frame period, the backlight module provides the red backlight of the three color backlights, and thereby the color filter of the first color sub-pixel, the color filter of the second color sub-pixel and the color filter of the third sub-pixel all allow the red backlight to pass through.

8. The field sequential color display device as claimed in claim 2, wherein the color filter of the first color sub-pixel is a color filter of a magenta sub-pixel, the color filter of the second color sub-pixel is a color filter of a yellow sub-pixel, and the color filter of the third sub-pixel is a color filter of a transparent sub-pixel;
in the first backlighting period of the first sub-frame period, the backlight module provides the blue backlight and the green backlight of the three color backlights, and thereby the color filter of the first color sub-pixel allows the blue backlight to pass through, the color filter of the second color sub-pixel allows the green backlight to pass through, and the color filter of the third sub-pixel allows the green backlight and the blue backlight to pass through; and
in the second backlighting period of the second sub-frame period, the backlight module provides the red backlight of the three color backlights, and thereby the color filter of the first color sub-pixel, the color filter of the second color sub-pixel and the color filter of the third sub-pixel all allow the red backlight to pass through.

9. The field sequential color display device as claimed in claim 3, wherein the color filter of the first color sub-pixel is a color filter of a magenta sub-pixel, the color filter of the second color sub-pixel is a color filter of a yellow sub-pixel, and the color filter of the third sub-pixel is a color filter of a transparent sub-pixel;
in the first backlighting period of the first sub-frame period, the backlight module provides the blue backlight and the green backlight of the three color backlights, and thereby the color filter of the first color sub-pixel allows the blue backlight to pass through, the color filter of the second color sub-pixel allows the green backlight to pass through, and the color filter of the third sub-pixel allows the green backlight and the blue backlight to pass through; and
in the second backlighting period of the second sub-frame period, the backlight module provides the red backlight of the three color backlights, and thereby the color filter of the first color sub-pixel, the color filter of the second color sub-pixel and the color filter of the third sub-pixel all allow the red backlight to pass through.

10. The field sequential color display device as claimed in claim 1, wherein the color filter of the first color sub-pixel is a color filter of a magenta sub-pixel, the color filter of the second color sub-pixel is a color filter of a cyan sub-pixel, and the color filter of the third sub-pixel is a color filter of a transparent sub-pixel;
in the first backlighting period of the first sub-frame period, the backlight module provides the red backlight and the green backlight of the three color backlights, and thereby the color filter of the first color sub-pixel allows the red backlight to pass through, the color filter of the second color sub-pixel allows the green backlight to pass through, and the color filter of the third sub-pixel allows the green backlight and the red backlight to pass through; and
in the second backlighting period of the second sub-frame period, the backlight module provides the blue backlight of the three color backlights, and thereby the color filter of the first color sub-pixel, the color filter of the second color sub-pixel and the color filter of the third sub-pixel all allow the blue backlight to pass through.

11. The field sequential color display device as claimed in claim 2, wherein the color filter of the first color sub-pixel is a color filter of a magenta sub-pixel, the color filter of the second color sub-pixel is a color filter of a cyan sub-pixel, and the color filter of the third sub-pixel is a color filter of a transparent sub-pixel;
in the first backlighting period of the first sub-frame period, the backlight module provides the red backlight and the green backlight of the three color backlights, and thereby the color filter of the first color sub-pixel allows the red backlight to pass through, the color filter of the second color sub-pixel allows the green backlight to pass through, and the color filter of the third sub-pixel allows the green backlight and the red backlight to pass through; and
in the second backlighting period of the second sub-frame period, the backlight module provides the blue backlight of the three color backlights, and thereby the color filter of the first color sub-pixel, the color filter of the second color sub-pixel and the color filter of the third sub-pixel all allow the blue backlight to pass through.

12. The field sequential color display device as claimed in claim 3, wherein the color filter of the first color sub-pixel is a color filter of a magenta sub-pixel, the color filter of the second color sub-pixel is a color filter of a cyan sub-pixel, and the color filter of the third sub-pixel is a color filter of a transparent sub-pixel;
in the first backlighting period of the first sub-frame period, the backlight module provides the red backlight and the green backlight of the three color backlights, and thereby the color filter of the first color sub-pixel allows the red backlight to pass through, the color filter of the second color sub-pixel allows the green backlight to pass through, and the color filter of the third sub-pixel allows the green backlight and the red backlight to pass through; and
in the second backlighting period of the second sub-frame period, the backlight module provides the blue backlight of the three color backlights, and thereby the color filter of the first color sub-pixel, the color filter of the second color sub-pixel and the color filter of the third sub-pixel all allow the blue backlight to pass through.

13. A color control method of a field sequential color display device, wherein the field sequential color display device comprises a liquid crystal display panel and a backlight module, the liquid crystal display panel comprises a color filter of a first color sub-pixel, a color filter of a second color sub-pixel, and a color filter of a third sub-pixel, the backlight module is configured for providing a backlight source to the liquid crystal display panel, the backlight source comprises a red backlight, a blue backlight and a green backlight; the color control method comprising:
dividing a frame period of the liquid crystal display panel sequentially into a first sub-frame period and a second sub-frame period;
in a first backlighting period of the first sub-frame period, providing two color backlights of the three color backlights and thereby the color filter of the first color sub-pixel allowing one color backlight of the two color backlights to pass through, the color filter of the second color sub-pixel allowing the other one color backlight of the two color backlights to pass through, and the color filter of the third sub-pixel allowing the two color backlights to pass through; and
in a second backlighting period of the second sub-frame period, providing the third color backlight of the three color backlights and thereby the color filter of the first color sub-pixel, the color filter of the second color sub-pixel and the color filter of the third sub-pixel all allowing the third color backlight of the three color backlights to pass through.

14. The color control method as claimed in claim 13, wherein before the step of providing two color backlights of the three color backlights in a first backlighting period of the first sub-frame period, the color control method further comprises:
in the first sub-frame period, supplying two color image data corresponding to the two color backlights to the liquid crystal display panel; and
before the step of providing the third color backlight of the three color backlights in a second backlighting period of the second sub-frame period, the color control method further comprises:
in the second sub-frame period, supplying color image data corresponding to the third color backlight of the three color backlights to the liquid crystal display panel.

15. The color control method as claimed in claim 13, wherein
the step of providing two color backlights of the three color backlights in a first backlighting period of the first sub-frame period comprises:
in the first backlighting period of the first sub-frame period, enabling PWM control signals for controlling the two color backlights of the three color backlights, while disabling a PWM control signal for controlling the third color backlight of the three color backlights; and
the step of providing the third color backlight of the three color backlights in a second backlighting period of the second sub-frame period comprises:
in the second backlighting period of the second sub-frame period, disabling the PWM control signals for controlling the two color backlights of the three color backlights, while enabling the PWM control signal for controlling the third color backlight of the three color backlights.

16. The color control method as claimed in claim 13, wherein the color filter of the first color sub-pixel is a color filter of a yellow sub-pixel, the color filter of the second color sub-pixel is a color filter of a cyan sub-pixel, and the color filter of the third sub-pixel is a color filter of a transparent sub-pixel.

17. The color control method as claimed in claim 13, wherein the color filter of the first color sub-pixel is a color filter of a magenta sub-pixel, the color filter of the second color sub-pixel is a color filter of a yellow sub-pixel, and the color filter of the third sub-pixel is a color filter of a transparent sub-pixel.

18. The color control method as claimed in claim 13, wherein the color filter of the first color sub-pixel is a color filter of a magenta sub-pixel, the color filter of the second color sub-pixel is a color filter of a cyan sub-pixel, and the color filter of the third sub-pixel is a color filter of a transparent sub-pixel.
